(19) United States
(12) Patent Application Publication
(10) Pub. No.: US 2020/0369003 A1
(43) Pub. Date: Nov. 26, 2020

(54) SOLAR CONTROL COMPOSITE FILM

(71) Applicant: SAINT-GOBAIN PERFORMANCE PLASTICS CORPORATION, Solon, OH (US)

(72) Inventors: Antoine DIGUET, Paris (FR); Daniele COSTANTINI, Paris (FR)

(21) Appl. No.: 16/874,846

(22) Filed: May 15, 2020

Related U.S. Application Data
(60) Provisional application No. 62/851,743, filed on May 23, 2019.

(51) Int. Cl. B32B 15/082; B32B 37/02; B32B 17/06; B32B 27/30; B32B 27/36; B32B 15/09; B32B 38/10; B32B 3/10

(52) U.S. Cl. CPC B32B 15/082; B32B 37/02; B32B 17/061; B32B 27/304; B32B 27/36; B32B 15/09; B32B 2255/205; B32B 3/10; B32B 2307/42; B32B 2307/416; B32B 2605/006; B32B 2255/10; B32B 38/10

(57) ABSTRACT

A composite film may include a discontinuous silver-based functional film, and a PVB over-layer overlying the discontinuous silver-based functional film. The composite film may have an R/sq value of at least about 30 Ohm/sq.

### CROSS-REFERENCE TO RELATED APPLICATION(S)

This application claims priority under 35 U.S.C. § 119(e) to U.S. Provisional Patent Application No. 62/851,743, entitled “SOLAR CONTROL COMPOSITE FILM,” filed May 23, 2019, naming as inventors Antoine DIGUET et al., which is assigned to the current assignee hereof and incorporated herein by reference in its entirety.

### FIELD OF THE DISCLOSURE

The present disclosure relates to a solar control film. In particular, the present disclosure relates to a solar control film having particular solar energy characteristics and high radio-frequency (i.e., RF) transparency that may be configured for use on an automobile window or an automobile sunroof.

### BACKGROUND

Composite films can be used as coverings applied to windows in building or vehicles to control the passage of solar radiation through transmission, reflection, and absorption. For certain composite films, visible light transmission and reflection must be low and the total solar energy rejection must be high. However, such composite films also attenuate radio-frequencies from passing through the film. In certain circumstances, a need exists for composite films which have superior visible light transmittance, visible light reflection, and total solar energy rejection properties at the desired levels in combination with high RF transparency.

### SUMMARY

According to a first aspect, a composite film may include a discontinuous silver-based functional film, and a PVB over-layer overlying the discontinuous silver-based functional film. The composite film may have an R/sq value of at least about 30 Ohm/sq.

According to a yet another aspect, a laminate may include a first substrate, a discontinuous silver-based functional film overlying the first substrate, a PVB over-layer overlying the discontinuous silver-based functional film, and a second substrate overlying the PVB over-layer. The laminate may have an R/sq value of at least about 30 Ohm/sq.

According to still another aspect, a method of forming a composite film may include providing a silver-based functional film attached to a first surface of a sacrificial film, conducting a first lamination of a PVB over-layer onto a second surface of the silver-based functional film, where the silver-based functional film is between the PVB over-layer and the sacrificial film, conducting a delamination of the silver-based functional film from the sacrificial film to form a discontinuous silver-based functional film attached to the PVB over-layer.

### BRIEF DESCRIPTION OF THE DRAWINGS

Embodiments are illustrated by way of example and are not limited in the accompanying figures.

FIG. 1 includes an diagram illustrating of a composite film forming method according to certain embodiments described herein;

FIG. 2 includes an illustration of an example composite film according to certain embodiments described herein;

FIG. 3 includes an illustration of a discontinuous silver-based functional film according to certain embodiments described herein; and

FIG. 4 includes an illustration of an example laminate include a composite film according to certain embodiments described herein.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention. Further, the use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

As used herein, the term “visible light transmission” or “VLT” refers to the ratio of total light visible to the human eye (i.e., having a wavelength between 380 nm and 780 nanometers) that is transmitted through a composite stack/transparent substrate system and may be calculated using a D65 light source at a 10° angle based on standard ISO9050.

The term “visible light reflection” or “VLR” refers to the ratio of total light visible to the human eye (i.e., having a wavelength between 380 nm and 780 nanometers) that is reflected by a composite stack/transparent substrate system and may be calculated using a D65 light source at a 10° angle based on standard ISO9050.

The term “visible light absorption” or “VLA” refers to the ratio of total light visible to the human eye (i.e., having a wavelength between 380 nm and 780 nanometers) that is absorbed by a composite stack/transparent substrate system and may be calculated using a D65 light source at a 10° angle based on standard ISO9050.

The term “solar energy transmission” or “TE” refers to the ratio of solar energy (having wavelength between 300 nm and 2500 nm) that is transmitted through the composite stack and is calculated based on standard ISO9050.

The term “solar energy reflection” or “RE” refers to the ratio of solar energy (having wavelength between 300 nm and 2500 nm) that is reflected by the composite stack and is calculated based on standard ISO9050.

The term “total solar energy transmitted” or “TTS” through the composite stack refers to the contribution of fraction of energy in addition to TE, which is absorbed and then reemitted, and which is calculated based on standard ISO13837.

The term haze lever or “Haze” is the ratio of the electromagnetic ray transmitted through a material, having a dispersion level higher than 2.5° regarding incidence direction of the ray and is calculated based on ISO 14782 and ASTMD1003

The term “sheet resistance” or “R/Sq” is the resistance of a film in which current is propagating along the plane of the film. The R/Sq value of the resistance is equal to sheet resistance when the film has a square shape and is independent on size of square edge. It is commonly measured with a 4-points probe measurement system, or with a non-contact measurement system relying on induction phenomenon.

It will be appreciated that for purposes of embodiments described herein, an optical property referred to as a “functional film” optical property (i.e., a functional film VLT, a functional film VLA, etc.) refers to the optical property measurement made with the functional film on a non-absorbing PET substrate 50.

It will be appreciated that for purposes of embodiments described herein, an optical property referred to as a “laminate” optical property (i.e., a laminate VLT, a laminate VLA, etc.) refers to the optical property measurement made with the laminate.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the solar control arts.

Embodiments described herein are generally directed to composite films and methods of forming composite films that include a discontinuous silver-based functional film, and a PVB over-layer overlying the discontinuous silver-based functional film. According to particular embodiments described herein, such composite films may have particular performance characteristics, such as, high visible light transmittance, low TTS and high RF transparency (i.e., a high R/sq value).

These concepts are better understood in view of the embodiments described below that illustrate and do not limit the scope of the present disclosure.

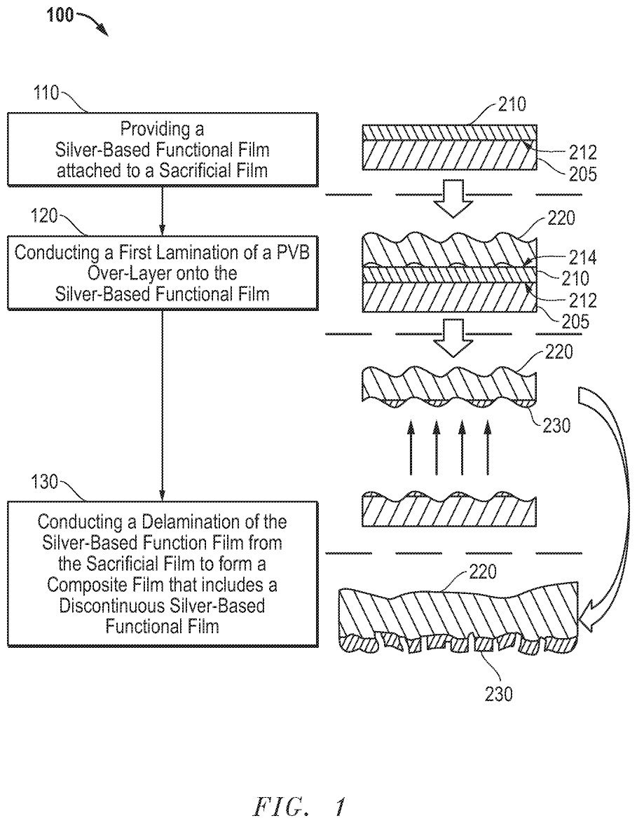

Referring first to methods of forming composite films according to embodiments described herein, FIG. 1 includes a diagram demonstrating a composite film formation method 100 for forming a composite film 200. According to particular embodiments, and as shown in FIG. 1, the composite film formation method 100 may include a first step 110 of providing a silver-based functional film 210 with a first surface 212 attached to a sacrificial film 205, a second step 120 of conducting a first lamination of a PVB over-layer 220 onto a second surface 214 of the silver-based functional film 210, where the silver-based functional film 210 is between the PVB over-layer 220 and the sacrificial film 205, a third step 130 of conducting a delamination of the silver-based functional film 210 from the sacrificial film 205 to form the composite film 200, where the discontinuous silver-based functional film 230 attached to the PVB over-layer 220.

Regarding the first step 110 of providing a silver-based functional film 210 with a first surface 212 attached to a sacrificial film 205, according to certain embodiments, the silver-based functional film 210 that is attached to the sacrificial film 205 may be a single silver-based functional layer. According to still other embodiments, the silver-based functional film 210 that is attached to the sacrificial film 205 may be a multi-layer composite film that includes at least one silver-based functional layer. It will be appreciated that the silver-based functional film 210 that is attached to the sacrificial film 205 may be a multi-layer composite film that further includes a sequence of additional layers made from various materials that are intended for various purposes, such as, for example, dielectric layers, blocker layer, growth layer or any combination thereof.

According to still other embodiments, the sacrificial film 205 may include a polyethylene terephthalate (PET) material. According to another particular embodiment, the sacrificial film 205 may consist of a PET material. According to still other embodiments, the sacrificial film 205 may be a PET film.

Now regarding second step 120 of conducting a first lamination of a PVB over-layer 220 onto a second surface 214 of the silver-based functional film 210, where the silver-based functional film 210 is between the PVB over-layer 220 and the sacrificial film 205, according to certain embodiments, the PVB over-layer 220 used in the first lamination step may have a particular thickness. For example, the PVB over-layer 220 used in the first lamination step may have an average thickness of at least about 0.015 mm, such as, at least about 0.02 mm or at least about 0.025 mm or at least about 0.03 mm or at least about 0.035 mm or at least about 0.04 mm or at least about 0.045 mm or at least about 0.05 mm or at least about 0.1 mm or at least about 0.15 mm or at least about 0.2 mm or at least about 0.25 mm or at least about 0.3 mm or at least about 0.35 mm or at least about 0.4 mm or at least about 0.45 mm or even at least about 0.5 mm. According to still other embodiments, the PVB over-layer 220 used in the first lamination step may have an average thickness of not greater than about 1 mm, such as, not greater than about 0.9 mm or even not greater than about 0.8 mm. It will be appreciated that the PVB over-layer 220 used in the first lamination step may have an average thickness within a range between any of minimum and maximum values noted above. It will be further appreciated that the PVB over-layer 220 used in the first lamination step may have an average thickness of any value between any of the minimum and maximum values noted above.

According to other embodiments, a first surface 222 of the PVB over-layer 220 used in the first lamination step may have a particular average surface roughness. For example, the first surface 222 of the PVB over-layer 220 used in the first lamination step may have an average surface roughness of at least about at least about 1 micron, such as, at least about 2 microns or at least about 3 microns or at least about 4 microns or at least about 5 microns or at least about 10 microns or at least about 15 microns or at least about 20 microns or at least about 25 microns or at least about 30 microns or at least about 35 microns or at least about 40 microns or even at least about 45 microns. According to yet other embodiments, the first surface 222 of the PVB over-layer 220 used in the first lamination step may have an average surface roughness of not greater than about 200 microns, such as, not greater than about 190 microns or not greater than about 180 microns or not greater than about170 microns or not greater than about 160 microns or not greater than about 150 microns or not greater than about 140 microns or not greater than about 130 microns or not greater than about 120 microns or not greater than about 110 microns or not greater than about 100 microns not greater than about 90 microns or not greater than about 80 microns or not greater than about 70 microns or even not greater than about 60 microns. It will be appreciated that the first surface 222 of the PVB over-layer 220 used in the first lamination step may have an average surface roughness within a range between any of minimum and maximum values noted above. It will be further appreciated that the first surface 222 of the PVB over-layer 220 used in the first lamination step may have an average surface roughness of any value between any of the minimum and maximum values noted above.

According to still other embodiments, the PVB over-layer 220 used in the first lamination step may have a second surface that does not contact the discontinuous silver-based functional film 230. According to certain embodiments, the second surface of the PVB over-layer 220 used in the first lamination step may have a particular average surface roughness. For example, the second surface of the PVB over-layer 220 used in the first lamination step may have an average surface roughness of at least about at least about 1 micron, such as, at least about 2 microns or at least about 3 microns or at least about 4 microns or at least about 5 microns or at least about 10 microns or at least about 15 microns or at least about 20 microns or at least about 25 microns or at least about 30 microns or at least about 35 microns or at least about 40 microns or even at least about 45 microns. According to yet other embodiments, the second surface of the PVB over-layer 220 used in the first lamination step may have an average surface roughness of not greater than about 200 microns, such as, not greater than about 190 microns or not greater than about 180 microns or not greater than about170 microns or not greater than about 160 microns or not greater than about 150 microns or not greater than about 140 microns or not greater than about 130 microns or not greater than about 120 microns or not greater than about 110 microns or not greater than about 100 microns or not greater than about 90 microns or not greater than about 80 microns or not greater than about 70 microns or even not greater than about 60 microns. It will be appreciated that the second surface of the PVB over-layer 220 used in the first lamination step may have an average surface roughness within a range between any of minimum and maximum values noted above. It will be further appreciated that the second surface 224 of the PVB over-layer 220 used in the first lamination step may have an average surface roughness of any value between any of the minimum and maximum values noted above.

Regarding third step 130 of conducting a delamination of the silver-based functional film 210 from the sacrificial film 205 to form a composite film 200, which includes a discontinuous silver-based functional film 230 attached to the PVB over-layer 220, according to certain embodiments, the discontinuous silver-based functional film 230 formed through the delamination step may be a single silver-based functional layer. According to still other embodiments, the discontinuous silver-based functional film 230 formed through the delamination step may be a multi-layer composite film that includes at least one silver-based functional layer. It will be appreciated that the discontinuous silver-based functional film 230 formed through the delamination step may be a multi-layer composite film that further includes a sequence of additional layers made from various materials that are intended for various purposes, such as, for example, dielectric layers, blocker layer, growth layer or any combination thereof.

According to still other embodiments, the discontinuous silver-based functional film 230 attached to the PVB over-layer 220 may receive additional treatments after formation. For example, the discontinuous silver-based functional film 230 attached to the PVB over-layer 220 may be stretched to enhance the function of the discontinuities of the discontinuous silver-based functional film 230 (i.e., widen the discontinuities).

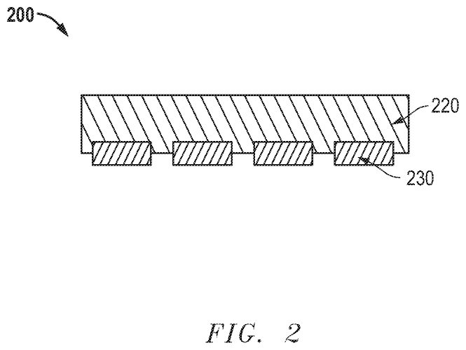

Referring now to the composite film 200 formed according to embodiments described herein, the composite film 200 may have a particular structure. FIG. 2 includes an illustration of a cross-sectional view of a portion of an embodiment of a composite film 200. As shown in FIG. 2, the composite film 200 may include a discontinuous silver-based functional film 230, and a PVB over-layer 220 overlying the discontinuous silver-based functional film 220.

According to particular embodiments, the discontinuous silver-based functional film 230 may be a single silver-based functional layer. According to still other embodiments, the discontinuous silver-based functional film 230 may be a multi-layer composite film that includes at least one silver-based functional layer. It will be appreciated that the discontinuous silver-based functional film 230 may be a multi-layer composite film that further includes a sequence of additional layers made from various materials that are intended for various purposes, such as, for example, dielectric layers, blocker layer, growth layer or any combination thereof.

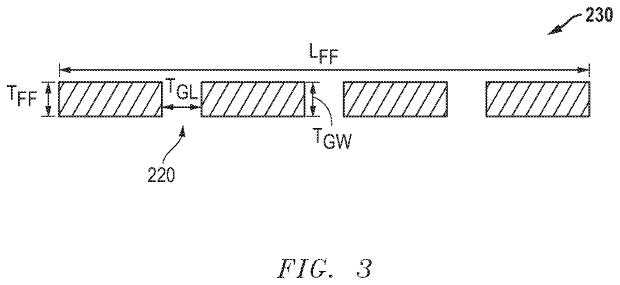

It will be appreciated that for purposes of embodiments described herein, a film or layer is considered discontinuous if it includes at least one discontinuity (i.e., a crack, gap or space in the film or layer) that passes entirely through the thickness of the film or layer and has sufficient dimensions (i.e., length and width) to allow that layers (or material from the layers) which encapsulate the film having the discontinuity to contact each other through the discontinuity. For purposes of illustration, FIG. 3 includes an illustration of cross-sectional view of a portion of a discontinuous functional film 230. As shown in FIG. 3, the discontinuous silver-based functional film 230 may have a length L_{FF} and an average thickness T_{FF}. Further, as shown in FIG. 3, the discontinuous silver-based functional film 230 may have at least one discontinuity 235. As noted above and as shown in FIG. 3, each of the discontinuities 235 may pass through the entire thickness T_{FF} of the discontinuous silver-based functional film 230 and may have a particular gap length T_{GL} and a particular gap width T_{GW}. Further, according to particular embodiments, a discontinuity 235 must also be of a sufficient size (i.e., have a sufficient gap length T_{GL}) such that materials from the layers surrounding both sides of the gap or space may come in contact with each other.

According to certain embodiments, a discontinuity 235 in the discontinuous silver-based functional film 230 may separate the discontinuous silver-based functional film 230 into distinct segments, meaning that the discontinuity 235 runs the entire width of the discontinuous silver-based functional film 230. According to still other embodiments, a discontinuity 234 of the discontinuous silver-based functional film 230 may meet not the film or layer into distinct segments (i.e., the discontinuity 235 resemble a hole in the discontinuous silver-based functional film 230, which does not run the entire width of the discontinuous silver-based functional film 230).

Referring back to FIG. 2, according to certain embodiments, the discontinuous silver-based functional film 230 may have at least one discontinuity having a dimension of a particular gap length T_{GL}. For example, the discontinuous silver-based functional film 230 may have at least one discontinuity having gap length T_{GL} of at least about 0.1 microns, such as, at least about 0.2 microns or at least about 0.3 microns or at least about 0.4 microns or at least about 0.5 microns or at least about 0.6 microns or at least about 0.7 microns or at least about 0.8 microns or at least about 0.9 microns or at least about 1 microns or at least about 2 microns or at least about 3 microns or at least about 4 microns or at least about 5 microns or at least about 6 microns or at least about 7 microns or at least about 8 microns or at least about 9 microns or at least about 10 microns or at least about 11 microns or at least about 12 microns or at least about 13 microns or at least about 14 microns or at least about 15 microns or at least about 16 microns or at least about 17 microns or at least about 18 microns or at least about 19 microns or at least about 20 microns or at least about 25 microns or at least about 30 microns or at least about 35 microns or at least about 40 microns or even at least about 50 microns. According to still other embodiments, the discontinuous silver-based functional film 230 may have at least one discontinuity having gap length T_{GL} of not greater an about 100 microns or not greater than about 90 microns or not greater than about 80 microns or not greater than about 70 microns or not greater than about 60 microns. It will be appreciated that the discontinuous silver-based functional film 230 may have at least one discontinuity having a gap length T_{GL} within a range between any of minimum and maximum values noted above. It will be further appreciated that the discontinuous silver-based functional film 230 may have at least one discontinuity having a gap length T_{GL} of any value between any of the minimum and maximum values noted above.

According to certain embodiments, the discontinuous silver-based functional film 230 may have at least one discontinuity having an average gap width T_{GW} of a particular size. For example, the discontinuous silver-based functional film 230 may have at least one discontinuity having an average gap width T_{GW} of at least about 10 microns, such as, at least about 11 microns or at least about 12 microns or at least about 13 microns or at least about 14 microns or at least about 15 microns or at least about 16 microns or at least about 17 microns or at least about 18 microns or at least about 19 microns or at least about 20 microns or at least about 25 microns or at least about 30 microns or at least about 35 microns or at least about 40 microns or even at least about 50 microns. According to still other embodiments, the discontinuous silver-based functional film 230 may have at least one discontinuity having an average gap width T_{GW} of not greater an about 100 microns or not greater than about 90 microns or not greater than about 80 microns or not greater than about 70 microns or not greater than about 60 microns. It will be appreciated that the discontinuous silver-based functional film 230 may have at least one discontinuity having an average gap width T_{GW} within a range between any of minimum and maximum values noted above. It will be further appreciated that the discontinuous silver-based functional film 230 may have at least one discontinuity having an average gap width T_{GW} of any value between any of the minimum and maximum values noted above.

According to still other embodiments, the discontinuous silver-based functional film 230 may have a particular number of discontinuities 235. For example, the discontinuous silver-based functional film 230 may have at least one discontinuity, such as, at least two discontinuities or at least three discontinuities or at least four discontinuities or at least about five discontinuities or at least six discontinuities or at least seven discontinuities or at least eight discontinuities or at least nine discontinuities or at least ten discontinuities.

According to still other embodiments, the discontinuities 235 of the discontinuous silver-based functional film 230 may have a regular distribution, meaning that the distances between the discontinuities 235 of the discontinuous silver-based functional film 230 are all the same. It will be appreciated that where the distances between the discontinuities 235 are regular, the discontinuities 235may appear within the discontinuous silver-based function film as a pattern (i.e., more structured in shape and size). According to still other embodiments, the discontinuities 235 of the discontinuous silver-based functional film 230 may have an irregular distribution, meaning that at least two of the distances between the discontinuities 235 of the discontinuous silver-based functional film 230 are different. It will be appreciated that where the distances between the discontinuities 235 are irregular, the discontinuities 235 may appear within the discontinuous silver-based function film as a compilation of cracks or gaps of random sizes and random distributions.

According to yet other embodiments, the discontinuous silver-based functional film 230 may have a particular thickness T_{FF}. For example, the discontinuous silver-based functional film 230 may have an average thickness T_{FF} of at least about 10 nm, such as, at least about 15 nm or at least about 20 nm or at least about 25 nm or at least about 30 nm or at least about 35 nm or at least about 40 nm or at least about 45 nm or at least about 50 nm or at least about 75 nm or at least about 100 nm or at least about 125 nm or at least about 150 nm or at least about 175 nm or at least about 200 nm or at least about 225 nm or even at least about 250 nm. According to still other embodiments, the discontinuous silver-based functional film 230 may have an average thickness T_{FF} of not greater than about 500 nm, such as, not greater than about 450 nm or not greater than about 400 nm or not greater than about 350 nm or even not greater than about 300 nm. It will be appreciated that the discontinuous silver-based functional film 230 may have an average thickness T_{FF} within a range between any of minimum and maximum values noted above. It will be further appreciated that the discontinuous silver-based functional film 230 may have an average thickness T_{FF} of any value between any of the minimum and maximum values noted above.

As noted herein, the discontinuous silver-based functional film 230 may include at least one silver-based functional layer. According to certain embodiments, the silver-based function layer of the discontinuous silver-based functional film 230 may have a particular thickness. For example, the silver-based function layer of the discontinuous silver-based functional film 230 may have an average thickness of at least about 4 nm, such as, at least about 5 nm or at least about 6 nm or at least about 7 nm or at least about 8 nm or at least about 9 nm or at least about 10 nm or at least about 11 nm or even at least about 12 nm. According to yet other embodiments, the silver-based function layer of the discontinuous silver-based functional film 230 may have an average thickness of not greater than about 20 nm or not greater than about 19 nm or not greater than about 18 nm or not greater than about 17 nm or not greater than about 16 nm or even not greater than about 15 nm. It will be appreciated that the silver-based function layer of the discontinuous silver-based functional film 230 may have an average thickness within a range between any of minimum and maximum values noted above. It will be further appreciated that the silver-based function layer of the discontinuous silver-based functional film 230 may have an average thickness of any value between any of the minimum and maximum values noted above.

According to still other embodiments, the discontinuous silver-based functional film 230 may have a particular functional film VLT. For example, the discontinuous silver-based functional film 230 may have a functional film VLT of at least about 1%, such as, at least about 5% or at least about 10% or at least about 15% or at least about 25% or at least about 30% or at least about 35% or at least about 40% or at least about 45% or at least about 50% or at least about 55% or at least about 60% or at least about 65% or at least about 70% or even at least about 75%. According to still other embodiments, the discontinuous silver-based functional film 230 may have a functional film VLT of not greater than about 99%. It will be appreciated that the discontinuous silver-based functional film 230 may have a functional film VLT within a range between any of minimum and maximum values noted above. It will be further appreciated that the discontinuous silver-based functional film 230 may have a functional film VLT of any value between any of the minimum and maximum values noted above.

According to still other embodiments, the discontinuous silver-based functional film 230 may have a particular functional film VLR. For example, the discontinuous silver-based functional film 230 may have a functional film VLR of at least about 1%, such as, at least about 3% or at least about 5% or even at least about 7%. According to still other embodiments, the discontinuous silver-based functional film 230 may have a functional film VLR of not greater than about 95%, such as, not greater than about 90% or not greater than about 85% or not greater than about 80% or not greater than about 75% or not greater than about 70% or not greater than about 65% or not greater than about 60% or not greater than about 55% or not greater than about 50% or not greater than about 45% or not greater than about 40% or not greater than about 35% or not greater than about 30% or not greater than about 25% or not greater than about 20% or even not greater than about 15%. It will be appreciated that the discontinuous silver-based functional film 230 may have a functional film VLR within a range between any of minimum and maximum values noted above. It will be further appreciated that the discontinuous silver-based functional film 230 may have a functional film VLR of any value between any of the minimum and maximum values noted above.

According to still other embodiments, the discontinuous silver-based functional film 230 may have a particular functional film VLA. For example, the discontinuous silver-based functional film 230 may have a functional film VLA of at least about 1%, such as, at least about 3% or at least about 5% or even at least about 7%. According to still other embodiments, the discontinuous silver-based functional film 230 may have a functional film VLA of not greater than about 95%, such as, not greater than about 90% or not greater than about 85% or not greater than about 80% or not greater than about 75% or not greater than about 70% or not greater than about 65% or not greater than about 60% or not greater than about 55% or not greater than about 50% or not greater than about 45% or not greater than about 40% or not greater than about 35% or not greater than about 30% or not greater than about 25% or not greater than about 20% or even not greater than about 15%. It will be appreciated that the discontinuous silver-based functional film 230 may have a functional film VLA within a range between any of minimum and maximum values noted above. It will be further appreciated that the discontinuous silver-based functional film 230 may have a functional film VLA of any value between any of the minimum and maximum values noted above.

According to still other embodiments, the discontinuous silver-based functional film 230 may have a particular functional film TE. For example, the discontinuous silver-based functional film 230 may have a functional film TE of at least about 2%, such as, at least about 5% or at least about 10% or at least about 25% or at least about 35% or even at least about 40%. According to still other embodiments, the discontinuous silver-based functional film 230 may have a functional film TE of not greater than about 80%, such as, not greater than about 70% or even not greater than about 60%. It will be appreciated that the discontinuous silver-based functional film 230 may have a functional film TE within a range between any of minimum and maximum values noted above. It will be further appreciated that the discontinuous silver-based functional film 230 may have a functional film TE of any value between any of the minimum and maximum values noted above.

According to still other embodiments, the discontinuous silver-based functional film 230 may have a particular functional film RE. For example, the discontinuous silver-based functional film 230 may have a functional film RE of at least about 10%, such as, at least about 15% or at least about 20%. According to still other embodiments, the discontinuous silver-based functional film 230 may have a functional film RE of not greater than about 70%, such as, not greater than about 60% or not greater than about 50% or not greater than about 40% or even not greater than about 30%. It will be appreciated that the discontinuous silver-based functional film 230 may have a functional film RE within a range between any of minimum and maximum values noted above. It will be further appreciated that the discontinuous silver-based functional film 230 may have a functional film RE of any value between any of the minimum and maximum values noted above.

According to still other embodiments, the discontinuous silver-based functional film 230 may have a particular functional film TTS. For example, the discontinuous silver-based functional film 230 may have a functional film TTS of at least about 10%, such as, at least about 25% or at least about 35% or even at least about 40%. According to still other embodiments, the discontinuous silver-based functional film 230 may have a functional film TTS of not greater than about 80%, such as, not greater than about 70% or even not greater than about 60%. It will be appreciated that the discontinuous silver-based functional film 230 may have a functional film TTS within a range between any of minimum and maximum values noted above. It will be further appreciated that the discontinuous silver-based functional film 230 may have a functional film TTS of any value between any of the minimum and maximum values noted above.

According to yet other embodiments, the PVB over-layer 220 may have a particular thickness. For example, the PVB over-layer 220 may have an average thickness of at least about 0.015 mm, such as, at least about 0.02 mm or at least about 0.025 mm or at least about 0.03 mm or at least about 0.035 mm or at least about 0.04 mm or at least about 0.045 mm or at least about 0.05 mm or at least about 0.1 mm or at least about 0.15 mm or at least about 0.2 mm or at least about 0.25 mm or at least about 0.3 mm or at least about 0.35 mm or at least about 0.4 mm or at least about 0.45 mm or even at least about 0.5 mm. According to still other embodiments, the PVB over-layer 220 may have an average thickness of not greater than about 1 mm, such as, not greater than about 0.9 mm or even not greater than about 0.8 mm. It will be appreciated that the PVB over-layer 220 may have an average thickness within a range between any of minimum and maximum values noted above. It will be further appreciated that the PVB over-layer 220 may have an average thickness of any value between any of the minimum and maximum values noted above.

Referring back to FIG. 2, the PVB over-layer 220 may have a first surface 222 that may contact the discontinuous silver-based functional film 230.

According to certain embodiments, the first surface 222 of the PVB over-layer 220 may have a particular average surface roughness. For example, the first surface 222 of the PVB over-layer 220 may have an average surface roughness of at least about at least about 1 micron, such as, at least about 2 microns or at least about 3 microns or at least about 4 microns or at least about 5 microns or at least about 10 microns or at least about 15 microns or at least about 20 microns or at least about 25 microns or at least about 30 microns or at least about 35 microns or at least about 40 microns or even at least about 45 microns. According to yet other embodiments, the first surface 222 of the PVB over-layer 220 may have an average surface roughness of not greater than about 200 microns, such as, not greater than about 190 microns or not greater than about 180 microns or not greater than about170 microns or not greater than about 160 microns or not greater than about 150 microns or not greater than about 140 microns or not greater than about 130 microns or not greater than about 120 microns or not greater than about 110 microns or not greater than about 100 microns or not greater than about 90 microns or not greater than about 80 microns or not greater than about 70 microns or even not greater than about 60 microns. It will be appreciated that the first surface 222 of the PVB over-layer 220 may have an average surface roughness within a range between any of minimum and maximum values noted above. It will be further appreciated that the first surface 222 of the PVB over-layer 220 may have an average surface roughness of any value between any of the minimum and maximum values noted above.

Referring back to FIG. 2, the PVB over-layer 220 may have a second surface 224 that does not contact the discontinuous silver-based functional film 230. According to certain embodiments, the second surface 224 of the PVB over-layer 220 may have a particular average surface roughness. For example, the second surface 224 of the PVB over-layer 220 may have an average surface roughness of at least about at least about 1 micron, such as, at least about 2 microns or at least about 3 microns or at least about 4 microns or at least about 5 microns or at least about 10 microns or at least about 15 microns or at least about 20 microns or at least about 25 microns or at least about 30 microns or at least about 35 microns or at least about 40 microns or even at least about 45 microns. According to yet other embodiments, the second surface 224 of the PVB over-layer 220 may have an average surface roughness of not greater than about 200 microns, such as, not greater than about 190 microns or not greater than about 180 microns or not greater than about170 microns or not greater than about 160 microns or not greater than about 150 microns or not greater than about 140 microns or not greater than about 130 microns or not greater than about 120 microns or not greater than about 110 microns or not greater than about 100 microns or not greater than about 90 microns or not greater than about 80 microns or not greater than about 70 microns or even not greater than about 60 microns. It will be appreciated that the second surface 224 of the PVB over-layer 220 may have an average surface roughness within a range between any of minimum and maximum values noted above. It will be further appreciated that the second surface 224 of the PVB over-layer 220 may have an average surface roughness of any value between any of the minimum and maximum values noted above.

According to still other embodiments, the composite film 200 may have a particular thickness. For example, the composite film 200 may have an average thickness of at least about 0.03 mm, such as, at least about 0.04 mm or at least about 0.05 mm or at least about 0.06 mm or at least about 0.07 mm or at least about 0.08 mm or at least about 0.09 mm or at least about 0.1 mm or at least about 0.15 mm or at least about 0.2 mm or at least about 0.25 mm or at least about 0.3 mm or at least about 0.35 mm or at least about 0.4 mm or at least about 0.45 mm or even at least about 0.5 mm. According to yet other embodiments, the composite film 200 may have an average thickness of not greater than about 2 mm or not greater than about 1.5 mm or not greater than about 1 mm. It will be appreciated that the composite film 200 may have an average thickness within a range between any of minimum and maximum values noted above. It will be further appreciated that the composite film 200 may have an average thickness of any value between any of the minimum and maximum values noted above.

According to yet other embodiments, the composite film 200 may have a particular R/sq value. For example, the composite film 200 may have an R/sq value or at least about 10 Ohm/sq, such as, at least about 20 Ohm/sq or at least about 30 Ohm/sq or at least about 40 Ohm/sq or at least about 50 Ohm/sq or at least about 60 Ohm/sq or at least about 70 Ohm/sq or at least about 80 Ohm/sq or at least about 90 Ohm/sq or at least about 100 Ohm/sq or at least about 110 Ohm/sq or at least about 120 Ohm/sq or at least about 130 Ohm/sq or at least about 140 Ohm/sq or at least about 150 Ohm/sq or at least about 160 Ohm/sq or at least about 170 Ohm/sq or at least about 180 Ohm/sq or at least about 190 Ohm/sq or at least about 200 Ohm/sq or at least about 210 Ohm/sq or at least about 220 Ohm/sq or at least about 230 Ohm/sq or at least about 240 Ohm/sq or even at least about 250 Ohm/sq. It will be appreciated that the composite film 200 may have an R/sq value between any of values noted above. It will be further appreciated that the composite film 200 may have an R/sq value of any value between any of the values noted above.

Alternative embodiments described herein are generally directed to laminate of a composite film and methods of forming the laminate. According to particular embodiments, such a laminate may be formed by laminating a composite film 200 formed according to embodiments described herein, between a first substrate and a second substrate. According to particular embodiments described herein, such laminates may have particular performance characteristics, such as, high visible light transmittance, low TTS and high RF transparency (i.e., a high R/sq value).

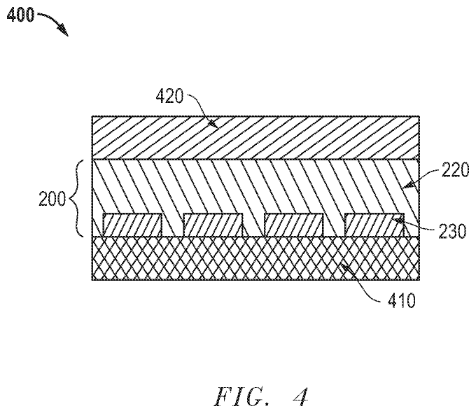

For purposes of illustrate, FIG. 4 includes an illustration of a cross-sectional view of a portion of an embodiment of a laminate 400 formed according to embodiments described herein. As shown in FIG. 4, a laminate 400 may include a first substrate 410, a second substrate 420 and a composite film 200 between the first substrate 410 and the second substrate 410. As shown in FIG. 4, the composite film 200 may include a discontinuous silver-based functional film 230, and a PVB over-layer 220 overlying the discontinuous silver-based functional film 220. Described another way and as also shown in FIG. 4, a laminate 400 may include a first substrate 410, a discontinuous silver-based functional film 230 overlying the first substrate 410, a PVB over-layer 220 overlying the discontinuous silver-based functional film 220, and a second substrate 420 overlying the PVB over-layer 220.

According to particular embodiments, the first substrate 410 may include a polymer material. According to another particular embodiment, the first substrate 410 may consist of a polymer material. According to still other embodiments, the first substrate 410 may be a polymer substrate layer. According to particular embodiments, the polymer substrate layer may include any desirable polymer material.

According to still other embodiments, the first substrate 410 may include a polyethylene terephthalate (PET) material. According to another particular embodiment, the first substrate 410 may consist of a PET material. According to still other embodiments, the first substrate 410 may be a PET substrate layer. According to particular embodiments, the PET substrate layer may include any desirable polymer material.

According to yet another embodiment, the first substrate 410 may include a glass material. According to yet another embodiment, the first substrate 410 may consist of a glass material. According to still another embodiment, the first substrate 410 may be a glass substrate layer. According to still other embodiments, the glass material may include any desirable glass material.

It will be further appreciated that when the first substrate 410 is a glass substrate layer.

According to certain embodiments, the first substrate 410 may have a particular thickness. For example, the first substrate 410 may have an average thickness of at least about 0.5 mm, such as, at least about 0.6 mm or at least about 0.7 mm or at least about 0.8 mm or at least about 0.9 mm or at least about 1.0 mm or at least about 1.5 mm or at least about 2.0 mm or even at least about 2.5 mm. According to still other embodiments, the first substrate 410 may have an average thickness of not greater than about 4 mm or not greater than about 3.75 mm or not greater than about 3.5 mm or not greater than about 3.25 mm or not greater than about 3.0 mm. It will be appreciated that the first substrate 410 may have an average thickness within a range between any of minimum and maximum values noted above. It will be further appreciated that the first substrate 410 may have an average thickness of any value between any of the minimum and maximum values noted above.

According to particular embodiments, the second substrate 420 may include a polymer material. According to another particular embodiment, the second substrate 420 may consist of a polymer material. According to still other embodiments, the second substrate 420 may be a polymer substrate layer. According to particular embodiments, the polymer substrate layer may include any desirable polymer material.

According to still other embodiments, the second substrate 420 may include a polyethylene terephthalate (PET) material. According to another particular embodiment, the second substrate 420 may consist of a PET material. According to still other embodiments, the second substrate 420 may be a PET substrate layer. According to particular embodiments, the PET substrate layer may include any desirable polymer material.

According to yet another embodiment, the second substrate 420 may include a glass material. According to yet another embodiment, the second substrate 420 may consist of a glass material. According to still another embodiment, the second substrate 420 may be a glass substrate layer. According to still other embodiments, the glass material may include any desirable glass material.

It will be further appreciated that when the second substrate 420 is a glass substrate layer.

According to certain embodiments, the second substrate 420 may have a particular thickness. For example, the second substrate 420 may have an average thickness of at least about 0.5 mm, such as, at least about 0.6 mm or at least about 0.7 mm or at least about 0.8 mm or at least about 0.9 mm or at least about 1.0 mm or at least about 1.5 mm or at least about 2.0 mm or even at least about 2.5 mm. According to still other embodiments, the second substrate 420 may have an average thickness of not greater than about 4 mm or not greater than about 3.75 mm or not greater than about 3.5 mm or not greater than about 3.25 mm or not greater than about 3.0 mm. It will be appreciated that the second substrate 420 may have an average thickness within a range between any of minimum and maximum values noted above. It will be further appreciated that the second substrate 420 may have an average thickness of any value between any of the minimum and maximum values noted above.

According to still other embodiments, the laminate 400 may have a particular thickness. For example, the laminate 400 may have an average thickness of at least about 1.0 mm, such as, at least about 2.0 mm or even at least about 3.0 mm. According to still other embodiment, the laminate 400 may have an average thickness of not greater than about 8 mm, such as, not greater than about 7 mm or even not greater than about 6 mm. It will be appreciated that the laminate 400 may have an average thickness within a range between any of minimum and maximum values noted above. It will be further appreciated that the laminate 400 may have an average thickness of any value between any of the minimum and maximum values noted above.

According to yet other embodiments, the laminate 400 may have a particular R/sq value. For example, the laminate 400 may have an R/sq value or at least about 10 Ohm/sq, such as, at least about 20 Ohm/sq or at least about 30 Ohm/sq or at least about 40 Ohm/sq or at least about 50 Ohm/sq or at least about 60 Ohm/sq or at least about 70 Ohm/sq or at least about 80 Ohm/sq or at least about 90 Ohm/sq or at least about 100 Ohm/sq or at least about 110 Ohm/sq or at least about 120 Ohm/sq or at least about 130 Ohm/sq or at least about 140 Ohm/sq or at least about 150 Ohm/sq or at least about 160 Ohm/sq or at least about 170 Ohm/sq or at least about 180 Ohm/sq or at least about 190 Ohm/sq or at least about 200 Ohm/sq or at least about 210 Ohm/sq or at least about 220 Ohm/sq or at least about 230 Ohm/sq or at least about 240 Ohm/sq or even at least about 250 Ohm/sq. It will be appreciated that the laminate 400 may have an R/sq value between any of values noted above. It will be further appreciated that the laminate 400 may have an R/sq value of any value between any of the values noted above.

According to still other embodiments, the laminate 400 may have a particular laminate VLT. It will be appreciated that the laminate VLT may be dependent on the clarity of the outer layers in the laminate (i.e., the clarity of the PVB layer or the glazings). For example, where the laminate 400 includes clear PVB layers (and other glazings), the laminate 400 may have a laminate VLT of at least about 1%, such as, at least about 5% or at least about 10% or at least about 15% or at least about 20% or at least about 25% or at least about 30% or at least about 35% or at least about 40% or at least about 45% or at least about 50% or at least about 55% or at least about 60% or at least about 65% or at least about 70% or even at least about 75%. According to still other embodiments, the laminate 400 may have a laminate VLT of not greater than about 99%. It will be appreciated that the laminate 400 may have a laminate VLT within a range between any of minimum and maximum values noted above. It will be further appreciated that the laminate 400 may have a laminate VLT of any value between any of the minimum and maximum values noted above.

It will further be appreciated that the composite film 200 may be used in a laminate with non-clear materials (i.e., dark substrate or PVB layers). In such applications, the laminate VLT may be low, for example, not greater than about 30%, such as, not greater than about 25% or not greater than about 20% or not greater than about 15% or not greater than about 10% or not greater than about 9% or not greater than about 8% or not greater than about 7% or not greater than about 6% or even not greater than about 5%.

According to still other embodiments, the laminate 400 may have a particular laminate VLR. For example, the laminate 400 may have a laminate VLR of at least about 1%, such as, at least about 3% or at least about 5% or even at least about 7%. According to still other embodiments, the laminate 400 may have a laminate VLR of not greater than about 99%, such as, not greater than about 95% or not greater than about 90% or not greater than about 85% or not greater than about 80% or not greater than about 75% or not greater than about 70% or not greater than about 65% or not greater than about 60% or not greater than about 55% or not greater than about 50% or not greater than about 45% or not greater than about 40% or not greater than about 35% or not greater than about 30% or not greater than about 25% or not greater than about 20% or even not greater than about 15%. It will be appreciated that the laminate 400 may have a laminate VLR within a range between any of minimum and maximum values noted above. It will be further appreciated that the laminate 400 may have a laminate VLR of any value between any of the minimum and maximum values noted above.

According to still other embodiments, the laminate 400 may have a particular laminate VLA. For example, the laminate 400 may have a laminate VLA of at least about 1%, such as, at least about 3% or at least about 5% or even at least about 7%. According to still other embodiments, the laminate 400 may have a laminate VLA of not greater than about 95%, such as, not greater than about 90% or not greater than about 85% or not greater than about 80% or not greater than about 75% or not greater than about 70% or not greater than about 65% or not greater than about 60% or not greater than about 55% or not greater than about 50% or not greater than about 45% or not greater than about 40% or not greater than about 35% or not greater than about 30% or not greater than about 25% or not greater than about 20% or even not greater than about 15%. It will be appreciated that the laminate 400 may have a laminate VLA within a range between any of minimum and maximum values noted above. It will be further appreciated that the laminate 400 may have a laminate VLA of any value between any of the minimum and maximum values noted above.

According to still other embodiments, the laminate 400 may have a particular laminate TE. For example, the laminate 400 may have a laminate TE of at least about 2%, such as, at least about 2% or at least about 5% or at least about 10% or at least about 25% or at least about 35% or even at least about 40%. According to still other embodiments, the laminate 400 may have a laminate TE of not greater than about 80%, such as, not greater than about 70% or even not greater than about 60%. It will be appreciated that the laminate 400 may have a laminate TE within a range between any of minimum and maximum values noted above. It will be further appreciated that the laminate 400 may have a laminate TE of any value between any of the minimum and maximum values noted above.

According to still other embodiments, the laminate 400 may have a particular laminate RE. For example, the laminate 400 may have a laminate RE of at least about 10%, such as, at least about 15% or at least about 20%. According to still other embodiments, the laminate 400 may have a laminate RE of not greater than about 70%, such as, not greater than about 60% or not greater than about 50% or not greater than about 40% or even not greater than about 30%. It will be appreciated that the laminate 400 may have a laminate RE within a range between any of minimum and maximum values noted above. It will be further appreciated that the laminate 400 may have a laminate RE of any value between any of the minimum and maximum values noted above.

According to still other embodiments, the laminate 400 may have a particular laminate TTS. For example, the laminate 400 may have a laminate TTS of at least about 10%, such as, at least about 25% or at least about 35% or even at least about 40%. According to still other embodiments, the laminate 400 may have a laminate TTS of not greater than about 80%, such as, not greater than about 70% or even not greater than about 60%. It will be appreciated that the laminate 400 may have a laminate TTS within a range between any of minimum and maximum values noted above. It will be further appreciated that the laminate 400 may have a laminate TTS of any value between any of the minimum and maximum values noted above.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A composite film comprising: a discontinuous silver-based functional film; and a PVB over-layer overlying the discontinuous silver-based functional film, wherein the composite film comprises an R/sq value of at least about 30 Ohm/sq.

Embodiment 2. A laminate comprising: a first substrate; a discontinuous silver-based functional film overlying a the first substrate; a PVB over-layer overlying the discontinuous silver-based functional film, and a second substrate overlying the PVB over-layer, wherein the laminate comprises an R/sq value of at least about 30 Ohm/sq.

Embodiment 3. A method of forming a composite film comprising providing a silver-based functional film attached to a first surface of a sacrificial film; conducting a first lamination of a PVB over-layer onto a second surface of the silver-based functional film, wherein the silver-based functional film is between the PVB over-layer and the sacrificial film; and conducting a delamination of the silver-based functional film from the sacrificial film to form a discontinuous silver-based functional film attached to the PVB over-layer to form a composite film.

Embodiment 4. The composite film, laminate or method of any one of embodiments 1, 2, and 3, wherein the discontinuous silver-based functional film comprises at least one discontinuity or at least about two discontinuities or at least about three discontinuities or at least about 4 discontinuities.

Embodiment 5. The composite film, laminate or method of embodiment 4, wherein the discontinuities of the discontinuous silver-based functional film have an average gap length of at least about 0.1 microns or at least about 0.2 microns or at least about 0.3 microns or at least about 0.4 microns or at least about 0.5 microns or at least about 0.6 microns or at least about 0.7 microns or at least about 0.8 microns or at least about 0.9 microns or at least about 1 microns or at least about 2 microns or at least about 3 microns or at least about 4 microns or at least about 5 microns or at least about 6 microns or at least about 7 microns or at least about 8 microns or at least about 9 microns or at least about 10 microns or at least about 10 microns or at least about 11 microns or at least about 12 microns or at least about 13 microns or at least about 14 microns or at least about 15 microns or at least about 16 microns or at least about 17 microns or at least about 18 microns or at least about 19 microns or at least about 20 microns or at least about 25 microns or at least about 30 microns or at least about 35 microns or at least about 40 microns or at least about 50 microns.

Embodiment 6. The composite film, laminate or method of embodiment 5, wherein the discontinuities of the discontinuous silver-based functional film have an average gap length of not greater an about 100 microns or not greater than about 90 microns or not greater than about 80 microns or not greater than about 70 microns or not greater than about 60 microns.

Embodiment 7. The composite film, laminate or method of any one of embodiments 1, 2, and 3, wherein the discontinuous silver-based functional film comprises an irregular distribution of discontinuities.

Embodiment 8. The composite film, laminate or method of any one of embodiments 1, 2, and 3, wherein the discontinuous silver-based functional film comprises a regular distribution of discontinuities.

Embodiment 9. The composite film, laminate or method of any one of embodiments 1, 2, and 3, wherein the discontinuous silver-based functional film comprises an average thickness of at least about 10 nm or at least about 15 nm or at least about 20 nm or at least about 25 nm or at least about 30 nm or at least about 35 nm or at least about 40 nm or at least about 45 nm or at least about 50 nm or at least about 75 nm or at least about 100 nm or at least about 125 nm or at least about 150 nm or at least about 175 nm or at least about 200 nm or at least about 225 nm or at least about 250 nm.

Embodiment 10. The composite film, laminate or method of any one of embodiments 1, 2, and 3, wherein the discontinuous silver-based functional film comprises an average thickness of not greater than about 500 nm or not greater than about 450 nm or not greater than about 400 nm or not greater than about 350 nm or not greater than about 300 nm.

Embodiment 11. The composite film, laminate or method of any one of embodiments 1, 2, and 3, wherein the discontinuous silver-based functional film comprises a silver-based functional layer.

Embodiment 12. The composite film, laminate or method of embodiment 11, wherein the discontinuous silver-based functional layer comprises an average thickness of at least about 4 nm or at least about 5 nm or at least about 6 nm or at least about 7 nm or at least about 8 nm or at least about 9 nm or at least about 10 nm or at least about 11 nm or at least about 12 nm.

Embodiment 13. The composite film, laminate or method of embodiment 12, wherein the discontinuous silver-based functional layer comprises an average thickness of not greater than about 20 nm or not greater than about 19 nm or not greater than about 18 nm or not greater than about 17 nm or not greater than about 16 nm or not greater than about 15 nm.

Embodiment 14. The composite film, laminate or method of any one of embodiments 1, 2, and 3, wherein the PVB over-layer comprises an average thickness of at least about 0.015 mm or at least about 0.02 mm or at least about 0.025 mm or at least about 0.03 mm or at least about 0.035 mm or at least about 0.04 mm or at least about 0.045 mm or at least about 0.05 mm or at least about 0.1 mm or at least about 0.15 mm or at least about 0.2 mm or at least about 0.25 mm or at least about 0.3 mm or at least about 0.35 mm or at least about 0.4 mm or at least about 0.45 mm or at least about 0.5 mm.

Embodiment 15. The composite film, laminate or method of embodiment 14, wherein the PVB over-layer comprises an average thickness of not greater than about 1 mm or not greater than about 0.9 mm or not greater than about 0.8 mm.

Embodiment 16. The composite film, laminate or method of any one of embodiments 1, 2, and 3, wherein the PVB over-layer comprises a first surface in contact with the discontinuous silver-based functional layer and wherein the first surface of the PVB over-layer comprises an average surface roughness of at least about at least about 1 micron or at least about 2 microns or at least about 3 microns or at least about 4 microns or at least about 5 microns or at least about 10 microns or at least about 15 microns or at least about 20 microns or at least about 25 microns or at least about 30 microns or at least about 35 microns or at least about 40 microns or at least about 45 microns.

Embodiment 17. The composite film, laminate or method of embodiment 16, wherein the first surface of the PVB over-layer comprises an average surface roughness of not greater than about 200 microns or not greater than about 190 microns or not greater than about 180 microns or not greater than about170 microns or not greater than about 160 microns or not greater than about 150 microns or not greater than about 140 microns or not greater than about 130 microns or not greater than about 120 microns or not greater than about 110 microns or not greater than about 100 microns or not greater than about 90 microns or not greater than about 80 microns or not greater than about 70 microns or not greater than about 60 microns.

Embodiment 18. The composite film, laminate or method of any one of embodiments 1, 2, and 3, wherein the PVB over-layer comprises a second surface not in contact with the discontinuous silver-based functional layer and wherein the second surface of the PVB over-layer comprises an average surface roughness of at least about at least about 1 micron or at least about 2 microns or at least about 3 microns or at least about 4 microns or at least about 5 microns or at least about 10 microns or at least about 15 microns or at least about 20 microns or at least about 25 microns or at least about 30 microns or at least about 35 microns or at least about 40 microns or at least about 45 microns.

Embodiment 19. The composite film, laminate or method of embodiment 18, wherein the second surface of the PVB over-layer comprises an average surface roughness of not greater than about 200 microns or not greater than about 190 microns or not greater than about 180 microns or not greater than about170 microns or not greater than about 160 microns or not greater than about 150 microns or not greater than about 140 microns or not greater than about 130 microns or not greater than about 120 microns or not greater than about 110 microns or not greater than about 100 microns or not greater than about 90 microns or not greater than about 80 microns or not greater than about 70 microns or not greater than about 60 microns.

Embodiment 20. The composite film of embodiment 1, wherein the composite film comprises an average thickness of at least about 0.03 mm or at least about 0.04 mm or at least about 0.05 mm or at least about 0.06 mm or at least about 0.07 mm or at least about 0.08 mm or at least about 0.09 mm or at least about 0.1 mm or at least about 0.15 mm or at least about 0.2 mm or at least about 0.25 mm or at least about 0.3 mm or at least about 0.35 mm or at least about 0.4 mm or at least about 0.45 mm or at least about 0.5 mm.

Embodiment 21. The composite film of embodiment 20, wherein the composite film comprises an average thickness of not greater than about 2 mm or not greater than about 1.5 mm or not greater than about 1 mm.

Embodiment 22. The composite film of embodiment 1, wherein the composite film comprises an R/sq value or at least about 10 Ohm/sq or at least about 20 Ohm/sq or at least about 30 Ohm/sq or at least about 40 Ohm/sq or at least about 50 Ohm/sq or at least about 60 Ohm/sq or at least about 70 Ohm/sq or at least about 80 Ohm/sq or at least about 90 Ohm/sq or at least about 100 Ohm/sq or at least about 110 Ohm/sq or at least about 120 Ohm/sq or at least about 130 Ohm/sq or at least about 140 Ohm/sq or at least about 150 Ohm/sq or at least about 160 Ohm/sq or at least about 170 Ohm/sq or at least about 180 Ohm/sq or at least about 190 Ohm/sq or at least about 200 Ohm/sq or at least about 210 Ohm/sq or at least about 220 Ohm/sq or at least about 230 Ohm/sq or at least about 240 Ohm/sq or at least about 250 Ohm/sq.

Embodiment 23. The composite film of embodiment 1, wherein the discontinuous silver-based functional film comprises a functional film VLT of at least about 1% or at least about 5% or at least about 10% or at least about 15% or at least about 20% or at least about 25% or at least about 30% or at least about 35% or at least about 40% or at least about 45% or at least about 50% or at least about 55% or at least about 60% or at least about 65% or at least about 70% or at least about 75%.

Embodiment 24. The composite film of embodiment 23, wherein the discontinuous silver-based functional film comprises a functional film VLT of not greater than about 99%.

Embodiment 25. The composite film of embodiment 1, wherein the discontinuous silver-based functional film comprises a functional film VLR of at least about 1% or at least about 3% or at least about 5% or at least about 7%.

Embodiment 26. The composite film of embodiment 25, wherein the discontinuous silver-based functional film comprises a functional film VLR of not greater than about 95% or not greater than about 90% or not greater than about 85% or not greater than about 80% or not greater than about 75% or not greater than about 70% or not greater than about 65% or not greater than about 60% or not greater than about 55% or not greater than about 50% or not greater than about 45% or not greater than about 40% or not greater than about 35% or not greater than about 30% or not greater than about 25% or not greater than about 20% or not greater than about 15%.

Embodiment 27. The composite film of embodiment 1, wherein the discontinuous silver-based functional film comprises a functional film VLA of at least about 1% or at least about 3% at least about 5% or at least about 7%.

Embodiment 28. The composite film of embodiment 27, wherein the discontinuous silver-based functional film comprises a functional film VLA of not greater than about 95% or not greater than about 90% or not greater than about 85% or not greater than about 80% or not greater than about 75% or not greater than about 70% or not greater than about 65% or not greater than about 60% or not greater than about 55% or not greater than about 50% or not greater than about 45% or not greater than about 40% or not greater than about 35% or not greater than about 30% or not greater than about 25% or not greater than about 20% or not greater than about 15%.

Embodiment 29. The composite film of embodiment 1, wherein the discontinuous silver-based functional film comprises a functional film TE of at least about 2% or at least about 5% or at least about 10% or at least about 25% or at least about 40%.

Embodiment 30. The composite film of embodiment 29, wherein the discontinuous silver-based functional film comprises a functional film TE of not greater than about 80% or not greater than about 70% or not greater than about 60%.

Embodiment 31. The composite film of embodiment 1, wherein the discontinuous silver-based functional film comprises a functional film RE of at least about 10% or at least about 15% or at least about 20%.

Embodiment 32. The composite film of embodiment 31, wherein the discontinuous silver-based functional film comprises a functional film RE of not greater than about 70% or not greater than about 60% or not greater than about 50% or not greater than about 40% or not greater than about 30%.

Embodiment 33. The composite film of embodiment 1, wherein the discontinuous silver-based functional film comprises a functional film TTS of at least about 10% or at least about 25% or at least about 40%.

Embodiment 34. The composite film of embodiment 33, wherein the discontinuous silver-based functional film comprises a functional film TTS of not greater than about 80% or not greater than about 70% or not greater than about 60%.

Embodiment 35. The laminate of embodiment 2, wherein the first substrate is a glass substrate.

Embodiment 36. The laminate of embodiment 2, wherein the first substrate comprises an average thickness of at least about 0.5 mm or at least about 0.6 mm or at least about 0.7 mm or at least about 0.8 mm or at least about 0.9 mm or at least about 1.0 mm or at least about 1.5 mm or at least about 2.0 mm or at least about 2.5 mm.

Embodiment 37. The laminate of embodiment 36, wherein the first substrate comprises an average thickness of not greater than about 4 mm or not greater than about 3.75 mm or not greater than about 3.5 mm or not greater than about 3.25 mm or not greater than about 3.0 mm.

Embodiment 38. The laminate of embodiment 2, wherein the second substrate is a glass substrate.

Embodiment 39. The laminate of embodiment 2, wherein the second substrate comprises an average thickness of at least about 0.5 mm or at least about 0.6 mm or at least about 0.7 mm or at least about 0.8 mm or at least about 0.9 mm or at least about 1.0 mm or at least about 1.5 mm or at least about 2.0 mm or at least about 2.5 mm.

Embodiment 40. The laminate of embodiment 39, wherein the second substrate comprises an average thickness of not greater than about 4 mm or not greater than about 3.75 mm or not greater than about 3.5 mm or not greater than about 3.25 mm or not greater than about 3.0 mm.

Embodiment 41. The laminate of embodiment 2, wherein the laminate comprises an average thickness of at least about 1.0 mm or at least about 2.0 mm or at least about 3.0 mm.

Embodiment 42. The laminate of embodiment 41, wherein the laminate comprises an average thickness of not greater than about 8 mm or not greater than about 7 mm or not greater than about 6 mm.

Embodiment 43. The laminate of embodiment 2, wherein the laminate comprises an R/sq value of at least about 10 Ohm/sq or at least about 20 Ohm/sq or at least about 30 Ohm/sq or at least about 40 Ohm/sq or at least about 50 Ohm/sq of at least about 60 Ohm/sq of at least about 70 Ohm/sq of at least about 80 Ohm/sq of at least about 90 Ohm/sq of at least about 100 Ohm/sq of at least about 110 Ohm/sq of at least about 120 Ohm/sq of at least about 130 Ohm/sq of at least about 140 Ohm/sq of at least about 150 Ohm/sq of at least about 160 Ohm/sq of at least about 170 Ohm/sq of at least about 180 Ohm/sq of at least about 190 Ohm/sq of at least about 200 Ohm/sq of at least about 210 Ohm/sq of at least about 220 Ohm/sq of at least about 230 Ohm/sq of at least about 240 Ohm/sq of at least about 250 Ohm/sq.

Embodiment 44. The laminate of embodiment 2, wherein the laminate comprises a laminate VLT of at least about 1% or at least about 5% or at least about 10% or at least about 15% or at least about 20% or at least about 25% or at least about 30% or at least about 35% or at least about 40% or at least about 45% or at least about 50% or at least about 55% or at least about 60% or at least about 65% or at least about 70% or at least about 75%.

Embodiment 45. The laminate of embodiment 44, wherein the laminate comprises a laminate VLT of not greater than about 99%.

Embodiment 46. The laminate of embodiment 2, wherein the laminate comprises a laminate haze value of not greater than about 10% or not greater than about 5% or not greater than about 2%.

Embodiment 47. The laminate of embodiment 2, wherein the laminate comprises a laminate VLR of at least about 1% or at least about 5% or at least about 7%.

Embodiment 48. The laminate of embodiment 47, wherein the laminate comprises a laminate VLR of not greater than about 95% or not greater than about 90% or not greater than about 85% or not greater than about 80% or not greater than about 75% or not greater than about 70% or not greater than about 65% or not greater than about 60% or not greater than about 55% or not greater than about 50% or not greater than about 45% or not greater than about 40% or not greater than about 35% or not greater than about 30% or not greater than about 25% or not greater than about 20% or not greater than about 15%.

Embodiment 49. The laminate of embodiment 2, wherein the laminate comprises a laminate VLA of at least about 1% or at least about 5% or at least about 7%.

Embodiment 50. The laminate of embodiment 49, wherein the laminate comprises a laminate VLA of not greater than about 95% or not greater than about 90% or not greater than about 85% or not greater than about 80% or not greater than about 75% or not greater than about 70% or not greater than about 65% or not greater than about 60% or not greater than about 55% or not greater than about 50% or not greater than about 45% or not greater than about 40% or not greater than about 35% or not greater than about 30% or not greater than about 25% or not greater than about 20% or not greater than about 15%.

Embodiment 51. The laminate of embodiment 2, wherein the laminate comprises a laminate TE of at least about 2% or at least about 5% or at least about 10% or at least about 25% or at least about 40%.

Embodiment 52. The laminate of embodiment 51, wherein the laminate comprises a laminate TE of not greater than about 80% or not greater than about 70% or not greater than about 60%.

Embodiment 53. The laminate of embodiment 2, wherein the laminate comprises a laminate RE of at least about 10% or at least about 15% or at least about 20%.

Embodiment 54. The laminate of embodiment 53, wherein the laminate comprises a laminate RE of not greater than about 70% or not greater than about 60% or not greater than about 50% or not greater than about 40% or not greater than about 30%.

Embodiment 55. The laminate of embodiment 2, wherein the laminate comprises a laminate TTS of at least about 10% or at least about 25% or at least about 40%.

Embodiment 56. The laminate of embodiment 55, wherein the laminate comprises a laminate TTS of not greater than about 80% or not greater than about 70% or not greater than about 60%.

### EXAMPLES

The concepts described herein will be further described in the following Examples, which do not limit the scope of the invention described in the claims.

### Example 1

A sample laminate of a composite film S1 was configured and formed according to certain embodiments described herein. The sample laminate S1 include a first glass substrate (i.e., bottom), a discontinuous silver-based functional film overlying the bottom glass substrate, a PVB over-layer overlying the discontinuous silver-based functional film, and a second glass substrate (i.e., top) overlying the PVB over layer. The discontinuous silver-based functional film has the following layer configuration: TiOx (25 nm)/Ag (11 nm)/TiOx (57 nm)/Ag (11 nm)/TiOx (28 nm)/PET (50 μm). It will be appreciated that the order of the layers listed for the discontinuous silver-based functional film indicate the order of the layers with the first layer listed corresponds to the top layer in the composite film.

The sample laminate S1 was formed according to embodiments described herein. Specifically, a PET film coated with the functional silver-based film was prelaminated with a 0.38 mm PVB layer, for example a RE11 PVB from Eastman. Prelamination was carried out by superimposing the coated PET film and the PVB layer in a vacuum created using standard vacuum sealing machine. The prelamination included 1 hour of heating in an oven at a temperature of between 30 ° C. and 55 ° C. After cooling down and opening of the vacuum pouch, delamination of the PET film from the PVB layer is carried out manually and the resulting component is stretched. Lamination with glass and a second PVB was then carried out using an autoclave process ant a temperature of 130° C. under a pressure of 12 bars.

A sample comparative laminate CS1 was configured and formed. The comparative sample laminate CS1 includes a first glass substrate (i.e., bottom), a continuous (i.e., not discontinuous) silver-based functional film overlying the first glass substrate, a PVB over-layer overlying the continuous silver-based functional film, and a second glass substrate (i.e., top) overlying the PVB over layer. The continuous silver-based functional film of CS1 includes the following layer configuration: TiOx (25 nm)/Ag (11 nm)/TiOx (57 nm)/Ag (11 nm)/TiOx (28 nm)/PET (50 μm).

Optical properties of each of the sample laminates S1 and the comparative sample laminate CS1 are summarized in Table 1 below. The summarized optical properties include: laminate VLT, laminate VLR, laminate TE, laminate RE, laminate RE, laminate TTS, HAZE, R/Sq. All optical properties were measured according to ISO 9050 using a Perkin Elmer Lambda 900 spectrophotometer.

TABLE 1
Sample Laminate Optical Property Measurements

| OPT. | | |
|---|---|---|
| PROP. | CS1 | S1 |
| VLT (%) | 78.1 | 76.1 |
| VLR (%) | 10.5 | 8.6 |
| VLA (%) | 11.8 | 15.3 |
| TE (%) | 49 | 43.3 |
| RE (%) | 29 | 29.1 |
| TTS (%) | 50.6 | 49.8 |
| HAZE (%) | 0.7 | 0.6 |
| R/Sq | 5 | 40 |
| (Ohm/sq) | | |

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A composite film comprising:
a discontinuous silver-based functional film; and
a PVB over-layer overlying the discontinuous silver-based functional film, wherein the composite film comprises an R/sq value of at least about 30 Ohm/sq.

2. The composite film of claim 1, wherein the discontinuous silver-based functional film comprises at least one discontinuity.

3. The composite film of claim 1, wherein the discontinuities of the discontinuous silver-based functional film have an average gap length of at least about 0.1 microns.

4. The composite film of claim 1, wherein the discontinuous silver-based functional film comprises an irregular distribution of discontinuities.

5. The composite film of claim 1, wherein the discontinuous silver-based functional film comprises a regular distribution of discontinuities.

6. The composite film of claim 1, wherein the discontinuous silver-based functional film comprises an average thickness of at least about 10 nm.

7. The composite film of claim 1, wherein the discontinuous silver-based functional film comprises a silver-based functional layer.

8. The composite film of claim 7, wherein the discontinuous silver-based functional layer comprises an average thickness of at least about 4 nm.

9. The composite film of claim 1, wherein the PVB over-layer comprises an average thickness of at least about 0.015 mm.

10. The composite film of claim 1, wherein the PVB over-layer comprises a first surface in contact with the discontinuous silver-based functional layer and wherein the first surface of the PVB over-layer comprises an average surface roughness of at least about at least about 1 micron.

11. The composite film of claim 1, wherein the PVB over-layer comprises a second surface not in contact with the discontinuous silver-based functional layer and wherein the second surface of the PVB over-layer comprises an average surface roughness of at least about at least about 1 micron.

12. The composite film of claim 1, wherein the composite film comprises an average thickness of at least about 0.03 mm.

13. The composite film of claim 1, wherein the composite film comprises an R/sq value or at least about 10 Ohm/sq.

14. A laminate comprising:
a first substrate;
a discontinuous silver-based functional film overlying a the first substrate;
a PVB over-layer overlying the discontinuous silver-based functional film, and
a second substrate overlying the PVB over-layer,
wherein the laminate comprises an R/sq value of at least about 30 Ohm/sq.

15. The laminate of claim 14, wherein the discontinuous silver-based functional film comprises at least one discontinuity.

16. The laminate of claim 14, wherein the discontinuities of the discontinuous silver-based functional film have an average gap length of at least about 0.1 microns.

17. The laminate of claim 14, wherein the discontinuous silver-based functional film comprises an irregular distribution of discontinuities.

18. The laminate of claim 14, wherein the discontinuous silver-based functional film comprises a regular distribution of discontinuities.

19. The laminate of claim 14, wherein the discontinuous silver-based functional film comprises an average thickness of at least about 10 nm.

20. A method of forming a composite film comprising
providing a silver-based functional film attached to a first surface of a sacrificial film;
conducting a first lamination of a PVB over-layer onto a second surface of the silver-based functional film, wherein the silver-based functional film is between the PVB over-layer and the sacrificial film; and
conducting a delamination of the silver-based functional film from the sacrificial film to form a discontinuous silver-based functional film attached to the PVB over-layer to form a composite film.
